(19) United States
(12) Patent Application Publication
(10) Pub. No.: US 2024/0161066 A1
(43) Pub. Date: May 16, 2024

(54) SYSTEM AND METHOD FOR ASSESSING VEHICLE DAMAGE

(71) Applicant: Computerized Vehicle Information Ltd., Hod Hasharon (IL)

(72) Inventors: Oren Gafni, Tel Aviv (IL); Uri Maimon, Hod Hasharon (IL)

(21) Appl. No.: 17/988,562

(22) Filed: Nov. 16, 2022

(51) Int. Cl. G06Q 10/00; G06K 9/62; G06Q 30/02

(52) U.S. Cl. CPC G06Q 10/20; G06K 9/6256; G06K 9/6267; G06Q 30/0278

(57) ABSTRACT

A method, system and computer program product, the method comprising: automatically deciding to use an agnostic prediction engine, agnostic to vehicle model and configured to provide an expected probability of each complex of parts of a model-less vehicle to be damaged by an impact of given impact characteristics; obtaining impact characteristics describing impact caused to a specific vehicle of a specific model; applying the agnostic prediction engine to the impact characteristics and the specific vehicle type, to predict of a list of complexes of parts of the model-less vehicle; mapping the list of complexes of parts of the model-less vehicle to a list of damaged parts of the specific vehicle which is larger than the list of complexes of parts of the model-less vehicle, wherein said mapping is performed utilizing a catalog of parts of the specific model; and reporting the list of damaged parts of the specific vehicle.

### TECHNICAL FIELD

The present disclosure relates to an automated system and method for assessing damages caused to vehicles by an impact.

### BACKGROUND

The damage caused to vehicles that have been in unique situations, particularly those involving sudden impacts such as accidents may be difficult to assess. The vehicle needs to be brought to a garage, a specialist such as a skilled appraiser needs to inspect the vehicle, examine the visible parts which are damaged, and realize the hidden parts which may be damaged as well. The specialist may then determine for each such part whether it needs to be repaired or replaced, the different repair or replacement alternatives and the corresponding prices, the cost of labor required for replacing or repairing the parts, or the like. The specialist may further have to assess the reduction in the market value of the vehicle once it is repaired. The assessment requires not only understanding of the general construct of a vehicle, but in some cases may also require knowledge related to specific car types or car models.

Thus, when a vehicle is damaged, the vehicle first needs to be brought to a garage, then an appraiser needs to arrive to the garage, sometime from far away, examine the car and fill a detailed report. This process may be time consuming and labor intensive, and therefore takes time and incur costs on the vehicle owner, the vehicle user and/or the insurance company.

### BRIEF SUMMARY

One exemplary embodiment of the disclosed subject matter is a computer-implemented method comprising: automatically deciding to use an agnostic prediction engine, wherein the agnostic prediction engine is agnostic to vehicle model, wherein the agnostic prediction engine is configured to provide an expected probability of each complex of parts of a model-less vehicle to be damaged by an impact of given impact characteristics; obtaining impact characteristics describing impact caused to a specific vehicle, the specific vehicle is of a specific vehicle model; applying the agnostic prediction engine to the impact characteristics and a type of the specific vehicle, to obtain a prediction of a list of complexes of parts of the model-less vehicle that have been damaged by the impact caused to the specific vehicle; mapping the list of complexes of parts of the model-less vehicle to a list of damaged parts of the specific vehicle, wherein the list of damaged parts is larger than the list of complexes of parts of the model-less vehicle, wherein said mapping is performed utilizing a catalog of parts of the specific vehicle model; and reporting the list of damaged parts of the specific vehicle. Within the method, said automatically deciding optionally comprises determining that a specific prediction engine has not been trained for the vehicle model. The method can further comprise using the impact characteristics and the list of complexes to train a specific engine for the specific vehicle model. The method can further comprise: obtaining second impact characteristics describing a second impact caused to a second vehicle, of the specific vehicle model; automatically deciding to use a specific prediction engine configured to provide an expected probability of each complex of parts of the second vehicle of the specific vehicle model to be damaged by an impact of the second impact characteristics; applying the specific prediction engine to the second impact characteristics, to obtain the specific prediction of the list of complexes of parts of the second vehicle that have been damaged by the second impact caused to the second vehicle; mapping the list of complexes of parts of the second vehicle to a list of damaged parts of the second vehicle, wherein the list of damaged parts is larger than the list of part complexes, wherein said mapping is performed utilizing a catalog of parts of the specific vehicle model; and reporting the list of damaged parts of the specific vehicle. Within the method, said agnostic model optionally receives as input a type of the specific vehicle. Within the method, the agnostic prediction engine or the specific prediction engine is optionally a classifier. Within the method, the specific prediction engine is optionally trained upon with a plurality of specific car models for which specific data is available. The method can further comprise: receiving from a user a correction to the at least one part or the degree of damage; and learning from the correction for improving future identification of the at least one part complex or the degree of damage. The method can further comprise: retrieving a price for replacing or repairing each part of the at least one part; outputting the price for each part of the at least one part; and outputting a total price calculated by summing the price for each part of the at least one part.

Another exemplary embodiment of the disclosed subject matter is a system having a processor, the processor being adapted to perform the steps of: automatically deciding to use an agnostic prediction engine, wherein the agnostic prediction engine is agnostic to vehicle model, wherein the agnostic prediction engine is configured to provide an expected probability of each complex of parts of a model-less vehicle to be damaged by an impact of given impact characteristics; obtaining impact characteristics describing impact caused to a specific vehicle, the specific vehicle is of a specific vehicle model; applying the agnostic prediction engine to the impact characteristics and a type of the specific vehicle, to obtain a prediction of a list of complexes of parts of the model-less vehicle that have been damaged by the impact caused to the specific vehicle; mapping the list of complexes of parts of the model-less vehicle to a list of damaged parts of the specific vehicle, wherein the list of damaged parts is larger than the list of complexes of parts of the model-less vehicle, wherein said mapping is performed utilizing a catalog of parts of the specific vehicle model; and reporting the list of damaged parts of the specific vehicle. Within the system, said automatically deciding optionally comprises determining that a specific prediction engine has not been trained for the vehicle model. Within the system, the processor or a second processor is optionally further configured to use the impact characteristics and the list of complexes to train a specific engine for the specific vehicle model. Within the system, the processor or the second processor is optionally further configured to: obtain second impact characteristics describing a second impact caused to a second vehicle, of the specific vehicle model; automatically decide to use a specific prediction engine configured to provide an expected probability of each complex of parts of the second vehicle of the specific vehicle model to be damaged by an impact of the second impact characteristics; applye the specific prediction engine to the second impact characteristics, to obtain the specific prediction of the list of complexes of parts of the second vehicle that have been damaged by the second impact caused to the second vehicle; map the list of complexes of parts of the second vehicle to a list of damaged parts of the second vehicle, wherein the list of damaged parts is larger than the list of part complexes, wherein said mapping is performed utilizing a catalog of parts of the specific vehicle model; and report the list of damaged parts of the specific vehicle. Within the system, said agnostic model optionally receives as input a type of the specific vehicle. Within the system, the agnostic prediction engine or the specific prediction engine is optionally a classifier. Within the system, the specific prediction engine is optionally trained upon with a plurality of specific car models for which specific data is available. Within the system, the processor is optionally further configured to: receive from a user a correction to the at least one part or the degree of damage; and learn from the correction for improving future identification of the at least one part complex or the degree of damage. Within the system, the processor is optionally further configured to: retrieve a price for replacing or repairing each part of the at least one part; output the price for each part of the at least one part; and output a total price calculated by summing the price for each part of the at least one part.

Yet another exemplary embodiment of the disclosed subject matter is a computer program product comprising a non-transitory computer readable medium retaining program instructions, which instructions when read by a processor, cause the processor to perform: automatically deciding to use an agnostic prediction engine, wherein the agnostic prediction engine is agnostic to vehicle model, wherein the agnostic prediction engine is configured to provide an expected probability of each complex of parts of a model-less vehicle to be damaged by an impact of given impact characteristics; obtaining impact characteristics describing impact caused to a specific vehicle, the specific vehicle is of a specific vehicle model; applying the agnostic prediction engine to the impact characteristics and a type of the specific vehicle, to obtain a prediction of a list of complexes of parts of the model-less vehicle that have been damaged by the impact caused to the specific vehicle; mapping the list of complexes of parts of the model-less vehicle to a list of damaged parts of the specific vehicle, wherein the list of damaged parts is larger than the list of complexes of parts of the model-less vehicle, wherein said mapping is performed utilizing a catalog of parts of the specific vehicle model; and reporting the list of damaged parts of the specific vehicle.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of collision between two cars;

FIG. 2 is an exemplary user interface for manually inputting the characteristics of an impact applied to a car, in accordance with some exemplary embodiments of the disclosed subject matter;

FIG. 3 is an exemplary user interface displaying parts that been damaged, and the required correction for each complex, in accordance with some exemplary embodiments of the disclosure;

FIG. 4 shows a table listing for each part the cost of repairing or replacing it, in accordance with some exemplary embodiments of the disclosure;

FIG. 5 is a flowchart of steps in a method for compiling part list for each part complex in a specific car model, in association with some exemplary embodiments of the disclosure;

FIG. 6 is a flowchart of steps in a method for training prediction engines for assessing car damage, in association with some exemplary embodiments of the disclosure;

FIG. 7 is a flowchart of steps in a method for, showing a flowchart of steps in a method for automatically assessing the damage caused to a vehicle, in accordance with some exemplary embodiments of the disclosure; and

FIG. 8 is a block diagram of a system for estimating damages caused to vehicles by impacts, in accordance with some exemplary embodiments of the disclosure.

### DETAILED DESCRIPTION

In the disclosure, the terms “car” or “vehicle” are used interchangeably and are to be widely construed to refer to any motorized machines that transports people or cargo, including cars, busses, trucks, tractors, boats, airplanes or the like.

In the disclosure, the terms “car model” or “vehicle model” are to be widely construed to cover any combination of a car manufacturer and a model, and optionally a year or a range of years in which cars or vehicles of the specific model have been manufactured. Cars of a specific car model may have variations such as 3/5 doors, with or without sunroof, various colors, or the like, but they share a general structure and a majority of parts.

In the disclosure, the terms “prediction model”, “prediction engine”, “AI engine”, or similar terms, are to be widely construed to cover any artificial intelligence (AI) engine, designed to receive input comprising an impact and car or car model details, and provide an output comprising a probability of a situation to take place given the other input parameters. For example, an engine may receive as input a car model, characteristics of impact applied to the car, and may output for one or more parts, part groups, or part complexes of the car, a probability that the part, part complex, or part group has been damaged with a specific severity, due to the impact. The prediction engine may be implemented using a variety of technologies, such as any type of Artificial Neural Network (ANN) including deep NN, convolutional NN, or others. The prediction engine may also be implemented using any other machine learning technology.

One technical problem dealt with by the disclosed subject matter relates to the difficulty in assessing the damage caused to a vehicle due to a certain impact. An expert, such as an appraiser, usually needs to examine the car, assess the damage caused to visible parts, estimate the damage caused to hidden parts, and estimate the labor and cost associated with repairing or replacing the damaged parts. It may be desired to avoid relying on human experts for each and every case, reducing the required resources to scale and handle a large volume of cases.

Another technical problem dealt with by the disclosed subject matter is that the expert may also need to make the distinction between damages caused by the specific impact and other damages, caused earlier or later. For example, if a third party is responsible for paying for the damages caused by the impact, the cost estimate must relate only to the damages caused by the current impact, and not by other causes. Hence, visual inspection of existing damage may be insufficient to determine what damage is actually related to the impact.

Yet another technical problem dealt with by the disclosed subject matter relates to situations in which an insufficient amount of data is available for satisfactory operation of a computerized system, as related to the relevant car model. In cases where computer systems rely on past cases to provide estimations, the accuracy and precision of the estimations may depend on the volume of past cases of the same car model. However, as new car models are launched every year, the challenge of providing accurate and precise estimation without pre-existing past cases of the same car model, needs to be tackled. The disclosed subject matter may be aimed at providing an estimation of damaged parts and their repair/replace costs regarding cars of car models for which limited data is available.

One technical solution comprises a method and system for automatic appraisal of the damage caused to a car by an impact, given the characteristics of the impact and the car model.

A prediction engine may be trained upon a plurality of historical cases. The input to the training of the prediction engine may comprise a plurality of cases. For each such case the provided features may include the relevant car model and additional details related to the car as well as the impact characteristics, including the area of the car that has been hit and the intensity of the hit. The label, i.e., the ground truth for each training case may be the part complexes of the car that have been damaged by the specific impact, and a degree of damage for each such part complex. The data may be collected from historical cases in which cars have been assessed after being hit in accidents. If historical data of the specific hit that caused known damage in specific cases is not available, it may be reverse-estimated by a professional such as an appraiser. For example, an appraiser may determine that severe damage to the front bumper and carburetor of a specific car model is due to a strong hit on the front central part of the car. Carburetor

It is appreciated that the collection of generic car parts for all vehicles is tremendous, for example about 10,000 parts. Only a fraction of the generic car parts are relevant for each specific car model, for example about 1,000 parts. Each such part may have different alternatives within the specific car model, for example having different colors, manufactured in different countries, absent rear doors for a 3-door car, or the like.

Out of all the generic car parts, only a small number of parts are likely to be hit in accidents, for example about 400-1000 of the about 10,000 parts. These parts may be divided into a smaller number of part complexes, also referred to as part groups or part complexes, wherein each such part complex comprises parts that are physically close to each other. For example, the number of part complexes may be between about 100 and about 200. A part complex may comprise a plurality of generic parts that are considered to be located in proximity. A part in a part complex may be considered to have a higher likelihood of being damaged by an impact that damaged another part in the same part complex, in comparison to its likelihood of being damaged by an impact that damaged another part in another part complex. For example, the group of “bumper front face” can include the parts of “upper bumper front face” and “lower bumper front face”.

For feasibility reasons, the prediction engine may be trained upon the part complexes, such that each training case comprises the impact characteristics, the car model and details, and the specific part complexes that have been damaged, and the severity of the damage.

Once the prediction engine is trained, it may receive as input a car model, additional details related to the car, and impact characteristics, and may output for one or more part complexes a probability that the part complex has been hit, and an assessed severity of the hit.

A breakdown of the damaged part complexes to distinct parts as relevant to the specific vehicle may then be obtained. For example, a front bumper of a specific car model may have an upper face and a lower face of the car color, each having its own catalogue number, and an associated cost of replace or repair.

The list of parts and the cost associated with each part may then be output. The list may or may not be subject to changes or approval of a human expert.

The damage assessment can be provided automatically to the driver, the car owner, the garage, the insurance company, the police or another law enforcement agency, or the like.

In some embodiments, one prediction engine may be provided which outputs the probabilities for all part complexes. In other embodiments, a set of prediction engines may be provided, wherein each prediction engine within the set is trained to output the probability for a specific part complex to be damaged, given the car model and details, and the specific hit characteristics. In some embodiments, a set of two or more prediction engines may be used, wherein at least one of the prediction engines is used for predicting the probability of two or more part complexes to be damaged.

It is appreciated that as more and more data for each car model is being collected, for example additional cases involving the specific car model are used for training, the prediction engine or set of prediction engines may be retrained to achieve more accurate assessments.

In some embodiments, the impact characteristics may be provided by a human, for example an appraiser examining the car, and assessing by the caused damage that the car was hit on the left rear side, in medium intensity. However, this again involves the presence of the human appraiser in the site of the car.

Thus, another technical solution comprises calculating the impact characteristics based on input received from a plurality of sensors, such as Inertial Measurement Unit (IMUs) sensors, accelerometers, Gyroscope or other force sensors installed within the vehicle or on a mobile device (e.g. a mobile phone) located within or otherwise associated with the vehicle. The sensors may be installed in a plurality of locations around the vehicle, and their reports related to the time immediately preceding and during the hit may be integrated into a unified hit area, hit direction, and severity. In some exemplary embodiments, the sensors may be affixed to a predetermined location within a precision threshold so as to ensure the readings can be utilized, or can be estimated in the case of using a non fixed device (e.g. a mobile phone). For example, the sensor may be affixed to the predetermined location and be located in such predetermined location or within a proximity of no more than a threshold distance therefrom (e.g., no more than 5 mm, 1 cm, 10 cm, 50 cm, or the like). The unified hit area and direction may be classified into one of a predetermined number of areas, for example 12 areas, and the severity may also be classified into a predetermined number of intensities, for example three or five possible intensity degrees. The calculated area and severity may then be input into the prediction engine together with the car model and car data, to obtain the part complexes expected to be damaged.

Another technical solution relates to a situation of a relatively new car models, for which no cases or not enough cases have been collected, such that the prediction engine could not have been trained, or could not have been trained to provide satisfactory results. In order to provide the functionality also for such car models, the car models are divided into a smaller number of car types, such as a passenger car, a convertible, a sportscar SUV, a truck, or the like. An additional prediction engine or set of prediction engines, referred to as an agnostic prediction engine may then be trained, which receives as input the car type instead of the car model.

In some exemplary embodiments, similarly to the specific precision engine, the agnostic prediction engine may be implemented as a set of agnostic prediction engines, each of which is designed to provide predictions for one or more part complexes to be damaged by a specific impact.

The agnostic prediction engine may be trained upon a plurality of cars of different brands and models, to provide an estimation of the damaged part complexes given a specific impact and the car type.

It is appreciated that the agnostic prediction engine may be trained upon the same cases as the specific prediction engine. However, the agnostic prediction engine may not receive as features the car model and the car details. In some exemplary embodiments, instead of receiving the car model and car details as features, the agnostic prediction engine may receive as features the car type.

For the avoidance of doubt, the terms “prediction engine” and “specific prediction engine” are to be construed to cover also the terms “specific set of prediction engines” and “set of prediction engines”, and the term “agnostic prediction engine” is to be construed to cover also the term “specific set of agnostic engines”.

Thus, when a vehicle of a car model for which no specific prediction engine has been trained is presented for assessment, the agnostic prediction engine may be used, and given an impact characteristics and the car type, outputs a list of part complexes that have likely been damaged and the damage extent.

The complexes may then be translated to the relevant parts of the complex, and a cost estimate for each such part and a total sum may be output.

In some exemplary embodiments, the case may also be utilized to train the specific prediction engine. In some exemplary embodiments, the training may be performed with each received case. Additionally or alternatively, once a sufficient number of cases is collected for a specific car model, the specific prediction engine may be trained to be able to provide predictions for the specific car model. After the specific prediction engine is sufficiently trained, when a car of that model is hit and it is required to assess the damage, the specific prediction engine may be applied instead of the agnostic prediction engine.

One technical effect of the disclosure provides for an efficient system and method for assessing damage caused to a car by a sudden impact. The damage may be assessed based only on the car model and details and the impact characteristics. Further, the damage may be assessed at any location and not necessarily in a garage, such that the vehicle can be towed directly to a suitable garage, be scrapped, or the like.

In some embodiments, when the car is installed with sensors, no professional appraiser may be required, and the damage can be assessed automatically on the spot. This may be particularly useful for minor accidents in which the involved drivers wish to agree on compensation without involving the insurance companies or complex administrative proceedings.

Another technical effect of the disclosure provides for obtaining an assessment even for car models for which insufficient data has been collected, such as new car models. However, as more data is collected, the specific prediction engine may be trained, such that future assessment for the specific car model are more accurate.

Yet another technical effect of the disclosure provides for distinguishing the damage caused to a vehicle due to a certain impact from other damages. By providing the impact characteristics, irrelevant parts or part complexes will not be reported as caused by the impact, thereby avoiding disputes about the extent of the damage.

The disclosed subject matter may provide for one or more technical improvements over any pre-existing technique and any technique that has previously become routine or conventional in the art. Additional technical problems, solutions and effects may be apparent to a person of ordinary skill in the art in view of the present disclosure.

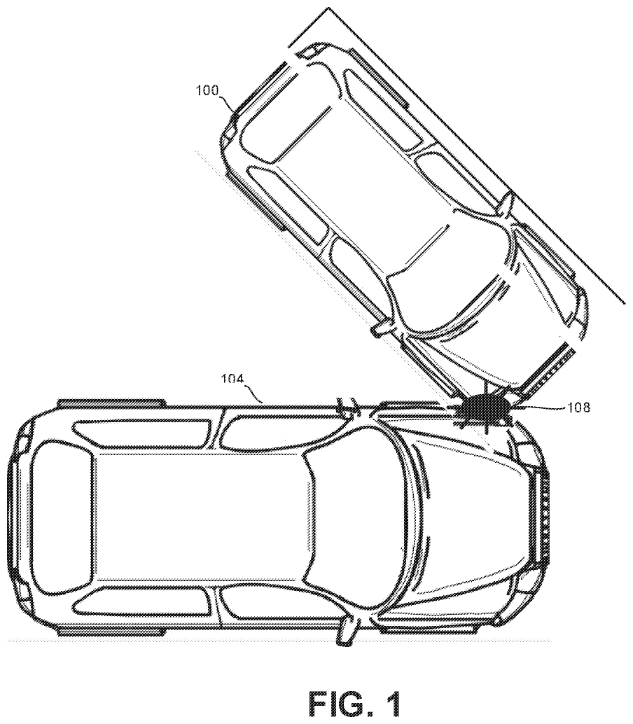

Referring now to FIG. 1, showing a schematic illustration of collision between car 100 and car 104. Contact area 108 is where the two cars collided. For each of the two cars this indicates a different area, as car 100 is hit in its front right area while car 104 is hit in its front left area. In addition, the hit severity is not necessarily the same for the two cars, for example car 104 may be hit harder than car 100. Thus, due to the differences in the cars and in the impact characteristics, the damages for the two cars may be significantly different, and the cost of repairing the cars may be very different.

In some embodiments, the drivers may wish to settle the payment between them, preferably on the spot. If the two cars, or at least the car whose driver is not responsible for the accident and needs to be compensated is equipped with IMU sensors, accelerometers, or the like, a detailed report of the parts to be repaired or replaced may be immediately available, such that the sides can settle the dispute

In other situations, each of the damaged cars may be brought to a garage or another location where an appraiser can examine them and assess the location and severity of the impact. The location and severity may be provided to a trained prediction engine, together with the car model and optionally additional data. If the car model is well known and the engine has been trained on data related thereto, the specific prediction engine trained on specific car models may be used, otherwise an agnostic prediction engine may be used, which receives as input the car type. The output of either prediction engine, including the list of parts and the relevant costs may be provided to the car owner, the driver, the garage, the insurance company, the police, or the like.

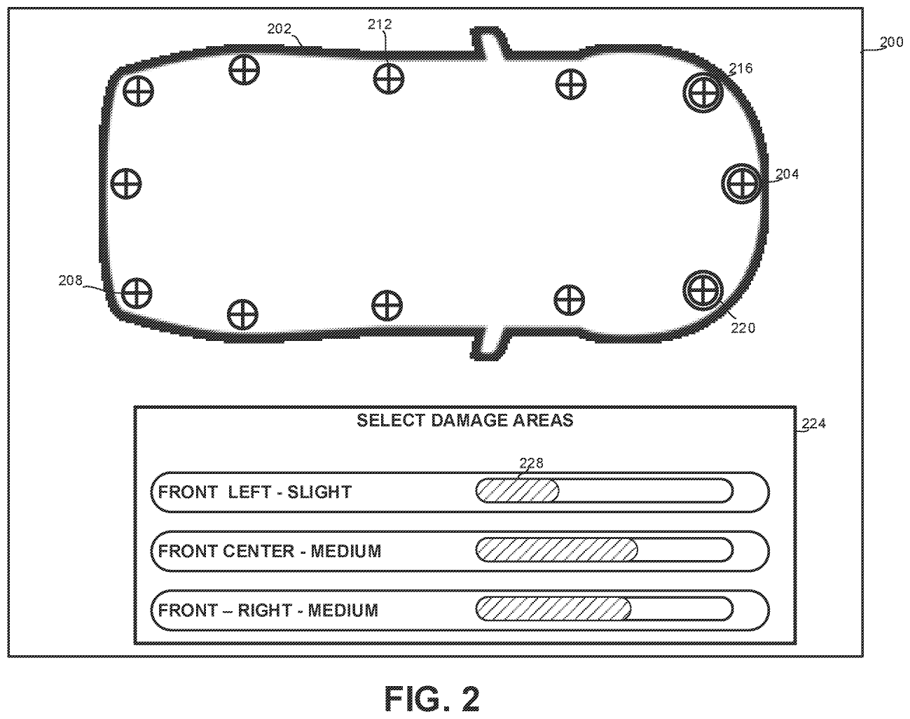

Referring now to FIG. 2, showing an exemplary user interface for manually inputting the characteristics of an impact applied to a car, in accordance with some exemplary embodiments of the disclosed subject matter.

User interface 200 may comprise a car outline 202 having marked thereon a plurality of markers, each indicating an area of the car that may be hit in an accident. For example area 204 is the front center, area 208 is the rear right, and area 212 is the left center.

A user may mark one or more areas that have been hit by an impact, for example front center area 212, front left 216 and front right 220.

Pane 224 displays a bar for each area selected on car outline 202, wherein the user can mark on the bar the degree of damage to the respective area. Thus, in the example of FIG. 2, the user has indicated on bar 228 that the damage to the front left area was slight, while the damages to the front center and the front right are medium. In other embodiments, the impact area and intensity may be provided by inputting text, vocal input, or the like.

It is appreciated that for cars equipped with sensors for sensing the location, direction and intensity of an impact, the user interface of FIG. 200 may be skipped, and the area and intensity may be calculated automatically by integrating the readings from the plurality of sensors. In some embodiments, a user may be shown the determined impact characteristics and can override the automatic determination by providing a different assessment of the hit area and intensity.

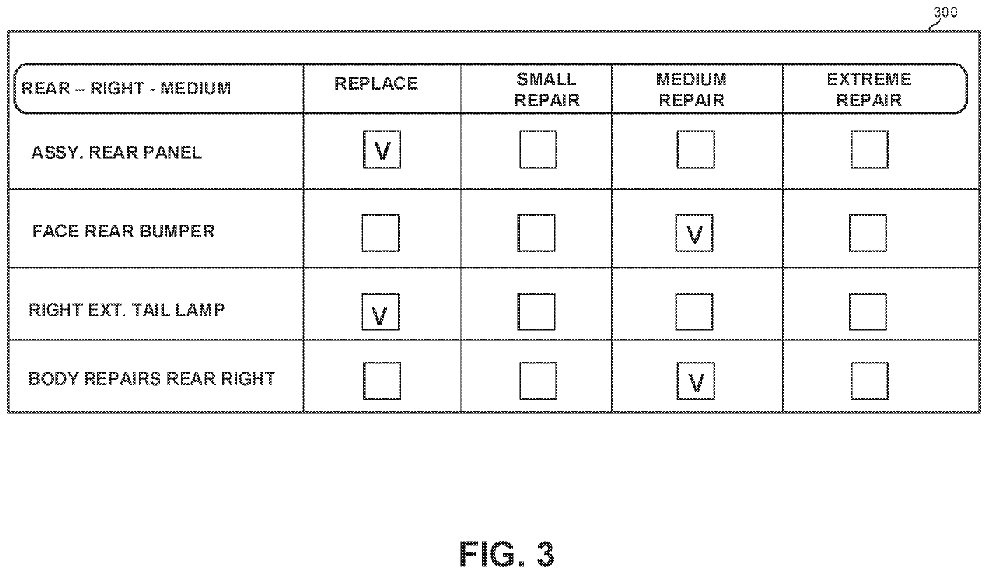

Referring now to FIG. 3, showing an exemplary user interface displaying the parts of the rear area which have been damaged, and the required repair/replace for each such part, in accordance with some exemplary embodiments of the disclosure. For each part it may be shown whether it needs to be replaced, or if it can be restored by a small/medium/extreme repair.

The list of parts may be obtained as follows: a list of part complexes that have been damaged, and the probable damage caused to each such part complex due to the impact, may be predicted by a prediction engine once the impact characteristics as shown on FIG. 2, and the car model and details are provided as input.

Whether the specific prediction engine or the agnostic prediction engine is used, depends on whether the specific prediction engine has been trained on a sufficient number of cases for the particular car model. If it has, then the specific prediction engine may be used, otherwise the agnostic prediction engine may be used.

For each part complex whose predicted probability to have been hit due to the specific impact exceeds a predetermined threshold, the parts from the global collection of parts which are mapped to this group, and which are also mapped to specific parts having one or more catalogue number within the specific car model may be retrieved.

For example, if the group of front bumper has been hit, it may be checked whether the parts thereof, being the upper front bumper face and the lower front bumper face are associated with specific parts for the relevant car model. These parts may then be reported, together with the associated repair/replace cost.

In some embodiments, a user such as an appraiser, or input from mechanisms such as an automatic damage image recognition mechanism, or other car sensors such as Radars, etc., may override the prediction of the prediction engine and mark different part complexes or different degrees of damage to the indicated part complexes.

If the agnostic prediction engine is used, its output is based on the information available for the type of vehicle, and not on the specific car model. If an appraiser amends the damage, for example changes the damaged complexes or the degree of damage, the provided data may be used for training the specific prediction engine and/or the agnostic prediction engine, such that in the future either engine can provide specific predictions for the car model.

However, even in cases where the specific prediction engine is used, if the appraiser amends the predicted damage, the amended prediction may also be used for retraining the specific engine, such that its future predictions are more accurate.

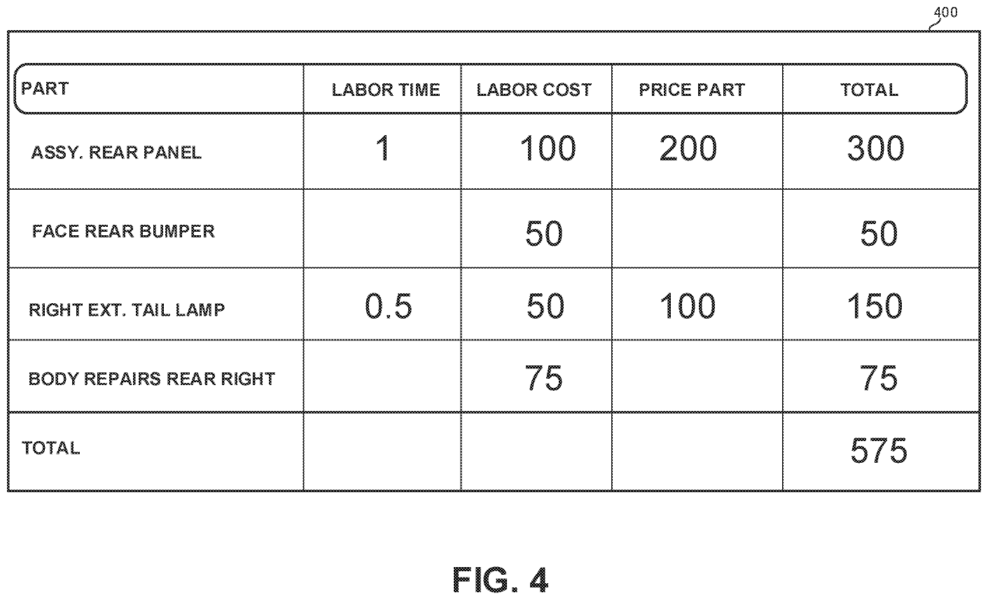

Referring now to FIG. 4, showing a table 400 listing for each part the cost of repairing or replacing it, including the labor and/or part price, in accordance with some exemplary embodiments of the disclosure. In some embodiments, table 400 may comprise additional columns, such as the price approved per each entry, the total price, or the like.

It will be appreciated that in the user interfaces shown in FIGS. 2-4, and additional stages, a human user, such as an appraiser may be able to override all automatic outputs, for example estimation of the impact, damaged parts, costs, etc. The amendments introduced by the user may be stored together with the automatically provided output, for purposes including learning, control, reporting, reviewing, or the like.

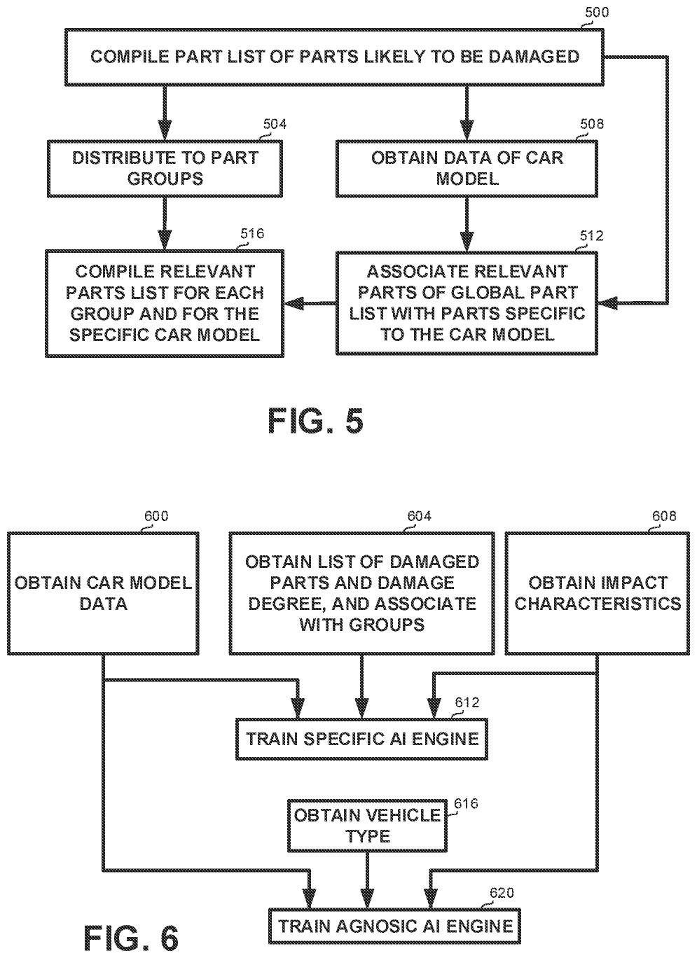

Referring now to FIG. 5, showing a flowchart of steps in a method for compiling a part list for each part complex in a specific car model, in association with some exemplary embodiments of the disclosure.

On step 500, a part list of the parts likely to be hit in an accident may be compiled. Step 500 may start with compiling a longer initial list, for example of all or most parts of all vehicles, and then reducing the list to the parts that are susceptible to be hit in an accident. The data about these parts may be collected from car catalogues in conjunction with data from insurance companies, garages, police reports, or the like. Thus, while the initial list may comprise for example 5000-10000 parts, the reduced list may comprise 500-1000 parts.

On step 504 the part list compiled on step 500 may be divided into part complexes, wherein each part complex comprises parts that are in physical proximity to each other and are likely to be replaced or repaired together. Step 504 does not depend on a specific car model, therefore the groups indicate complexes of parts of a model-less vehicle, i.e., a “general” vehicle. For example, the group of “bumper front face” can include the parts of upper bumper front face and lower bumper front face. The parts being in proximity to each other may relate to parts that are closer to each other than to other parts assigned to other groups. Additionally or alternatively, part complexes may relate to parts that are usually replaced together.

On step 508, data of a car model can be obtained, such as a part catalogue. The part catalogue may comprise one or more catalogue number for each part. For example, the same part can have different colors, be manufactured in different countries, or the like.

On step 512 parts of the part list compiled on step 500 may be correlated with parts of the specific car model, thereby assigning to a part of the list parts likely to be damaged one or more relevant catalogue numbers associated with the specific car model.

On step 516, a relevant part list for each relevant part group may be compiled for each car model. For example, the group of “front buffer”, may be associated with the catalogue numbers of the relevant parts in each car model. It is appreciated that not all part groups are associated with parts for any car model. For example, a part complex related to a trailer will not be present for a passenger car.

It is appreciated that if not enough data is available for the specific car model, the parts may remain on a model-less level, such as a “radiator” without a catalogue number.

It is appreciated that steps 508, 512 and 516 may be repeated for each car model, such that damages for cars of these models can be assessed automatically.

Referring now to FIG. 6, showing a flowchart of steps in a method for training prediction engines for assessing car damage, in accordance with some exemplary embodiments of the disclosure.

On steps 600, 604 and 608 details of a specific case, e.g., a specific accident, may be obtained. Step 600, 604 and 608 may be repeated a plurality of times per each car model to be handled by the system, in accordance with the number of cases available for the car model.

On step 600, the data of the car model may be obtained. The data may include the car model, the year in which the car was manufactured, the age of the car (which may not be consistent with the manufacturing year, for example if the car was stored for a period of time before it was sold), and possibly additional information which may affect the value or the vulnerability of the car or the repair cost.

On step 604, the list of damaged parts and damage degree caused by the impact may be obtained, for example from insurance company records, garage records, or the like. The parts may be consolidated into their respective groups as determined on step 504, to associate the impact with the damage caused to part complexes.

On step 608, the impact characteristics are obtained, including area of the car and severity. The area may be one or more of a predetermined number of areas, for example as shown in FIG. 2 above.

In other embodiments the impact characteristics as discussed in association with step 600 may be as obtained based upon the sensor readings, entered by a human, or the like.

In further embodiments, the impact characteristics may not be available. In such cases, the impact characteristics may be reverse-estimated from the damaged parts. In some embodiments, the area of the accident may be obtained from the location of the specific parts that were hit. For example, damage to the back bumper and the left taillight may indicate a hit on the rear left part of the car.

The severeness of the damage may be obtained from the number of the damaged parts, wherein a larger number of damaged parts indicate a more significant impact. In further embodiments, the specific parts that are damaged may also indicate the severity of the impact, wherein parts that are more internal may indicate a more significant hit. The factors above and additional ones may be combined, for example weighted to reverse-assess the impact severity. In some embodiments, multiple such combinations may be tested by entering data of cases for which the impact severity is known, and selecting the combination that provides results which are closer to the actual results.

On step 612, the specific prediction engine may be trained, by receiving as features the impact characteristics and the model data and additional data of the car, and as a label the damaged part complexes and the damage degree for each such part complex. The specific prediction engine may be associated with the car models for which it has been trained.

On step 616, the car type for the plurality of cases may be obtained. Each car is associated with a specific type, which may be easily retrieved from the car data, or entered manually. The vehicle type may be one of a number of predetermined general categories, such as but not limited to passenger car, commercial vehicle, microcar, convertible, sports car, station wagon, crossover SUV, sport utility vehicle (SUV), boat, sea bike, airplane, tractor, or others.

On step 620, an agnostic prediction engine may be trained as detailed on step 612 above, wherein the vehicle type may be used instead of the car model data. Thus, the agnostic prediction engine may be trained to predict the damaged part complexes for a vehicle of a general type, rather than a specific car model. The agnostic prediction engine may thus be useful for new models, for which insufficient amount of data is available to train the specific prediction engine.

It is appreciated that one or more cases may be used for training the specific prediction engine as well as the agnostic prediction engine. However, the agnostic prediction engine may receive as input the car type rather than the specific car model.

It is also appreciated that training, such as the training on step 612 or 620 may be performed by a computing platform other than the one used to assess damage to a specific car, for example by a server computing platform.

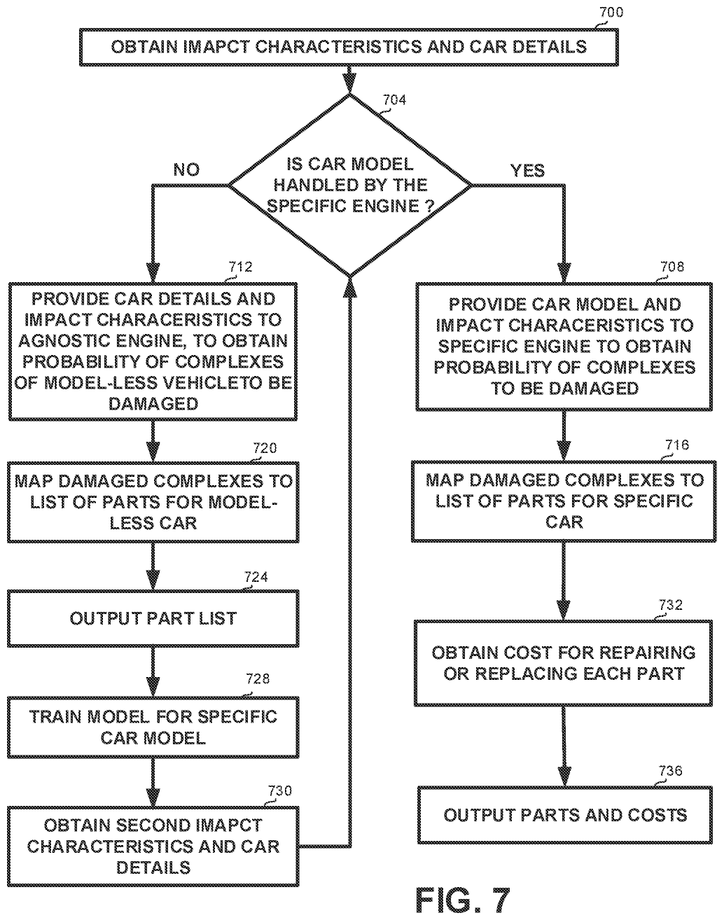

Referring now to FIG. 7, showing a flowchart of steps in a method for automatically assessing the damage caused to a vehicle, in accordance with some exemplary embodiments of the disclosure.

On step 700, impact characteristics and car details of a vehicle that has been damaged by the impact may be received. The impact characteristics may be obtained automatically by processing readings from sensors installed within the vehicle, or entered manually. The car details may include the car model, the manufacturing year, the vehicle age, and additional details.

On step 704 it may be determined whether the specific engine was trained upon the car model. Thus, if the specific engine was not trained upon the car model (“No”), it may be automatically decided to use an agnostic prediction engine, wherein the agnostic prediction engine is agnostic to vehicle model and is configured to provide an expected probability of each complex of parts of a model-less vehicle to be damaged by an impact having the given characteristics.

If the specific engine was trained upon the car model (“Yes”), then on step 708 the car details and the impact characteristics are provided to the specific prediction engine, to obtain a prediction of one or more part complexes having a probability exceeding a threshold to have been damaged, and the damage severity. For example, the engine may provide that the front buffer has been hit with medium damage.

On step 716, the part complexes of the vehicle for which the damage probability exceeded the threshold may be mapped to the specific parts associated with the specific car that has been damaged, as determined on step 516 of FIG. 5. For example, parts of the correct color may be selected, parts that are not present in the specific car may be omitted, or the like. It is appreciated that since at least one of the part complexes comprises multiple parts, the list of damaged parts is longer than the list of damaged part complexes.

On step 732, the cost and/or other details such as provisioning time, insurance coverage or the like may be obtained for the specific parts of the specific vehicle.

On step 736 the parts, costs and possibly additional details may be reported, for example sent in an e-mail message, SMS, stored in a database, or provided on any other virtual, visual or vocal medium to one or more recipients, such as the driver, the vehicle owner, the insurance company, a third party, or the like. In some embodiments, a user having sufficient privileges may change the report. In further embodiments, a user may change some parts of the report and not others. In some embodiments, a user may change only certain items for which the price is above/below a threshold, only reports whose total sum is above/below a threshold, or the like.

If on step 704 it is determined that the specific engine was not trained upon the car model (“No”), then on step 712 the agnostic prediction engine is applied to the impact characteristics and the car details including the car type, to obtain a prediction of a list of part complexes of a model-less vehicle that have been damaged by the impact caused to the specific vehicle. For each such part complex, a predicted probability to have been damaged may be provided, and a damage severity.

On step 720, the part complexes may be mapped to a list of damaged parts of the specific vehicle. It is appreciated that the list is longer than the list of complexes of parts of the model-less vehicle, since at least one part complex is mapped to multiple concrete parts of the specific vehicle.

On step 724 the part list may be output, optionally with prices or other details if available.

On step 728, the specific engine may be trained with the cases gathered after the previous training took place, such that future cases with the same car model can be handled by the specific engine. It is appreciated that step 728 may not be performed immediately but only after a sufficient number of cases has been collected for the car model, for example at least 5 cases, at least 50 cases, at least 100 cases, or the like. Training may be performed by a computing platform other than the one used for other steps, including assessing damage to vehicles.

Once the specific engine has been trained upon cases of the car model, on step 730 a second impact characteristics and car details related to a second case may be obtained.

Execution may then return to step 704, wherein if the specific prediction engine has been trained for the specific car model, the impact characteristics and car details may be provided to the specific prediction engine, to obtain prediction of one or more part complexes having a probability exceeding a threshold to have been damaged, and the damage severity.

The prediction may be more accurate than the predictions provided for the same car model by the agnostic engine, as the specific engine has been trained upon the car model.

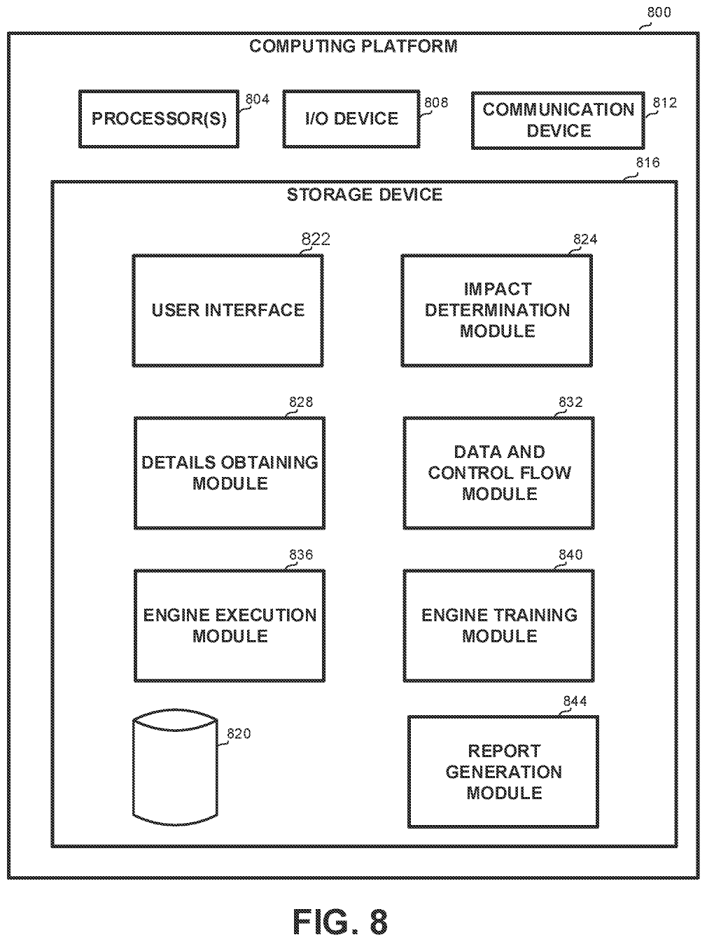

Referring now to FIG. 8, showing a block diagram of a system for estimating damages caused to vehicles by impacts, in accordance with some exemplary embodiments of the disclosure.

The system may comprise one or more Computing Platform(s) 800. In some embodiments, Computing Platform 800 may be located anywhere and accessed through a communication channel by one or more vehicles, insurance company networks, garages, or the like. In some embodiments, Computing Platform 800 may provide services over a network to one or more clients.

It will be appreciated that Computing Platform 800 may be implemented as one or more computing platforms collocated or not, which may be in communication with one another. It will also be appreciated that Processor 804 may be implemented as one or more processors, whether located on the same platform or not.

Computing Platform 800 may comprise a Processor 804 which may be one or more Central Processing Unit (CPU), a microprocessor, an electronic circuit, an Integrated Circuit (IC) or the like. Processor 804 may be configured to provide the required functionality, for example by loading to memory and activating the modules stored on Storage Device 816 detailed below.

Computing Platform 800 may also comprise Input/Output (I/O) Device 808 such as a display, a pointing device, a keyboard, a touch screen, or the like. I/O Device 808 may be utilized to receive input from and provide output to a user, for example enter car details, receive damaged part list, or the like.

Computing platform 800 may comprise Communication Device 812 for communicating with other computing platforms, for example a server or other computing platforms within a cloud, via any communication channel, such as a cellular network, Wide Area Network, a Local Area Network, intranet, Internet or the like.

Computing Platform 800 may also comprise a Storage Device 816, such as a hard disk drive, a Flash disk, a Random Access Memory (RAM), a memory chip, or the like. Storage Device 816 may also be distributed among two or more platforms, stored on cloud storage, or the like.

In some exemplary embodiments, Storage Device 816 may retain program code operative to cause Processor 804 to perform acts associated with any of the modules listed below or steps of the methods of FIGS. 5-7 above. The program code may comprise one or more executable units, such as modules, functions, libraries, standalone programs or the like, adapted to execute instructions as detailed below.

Storage Device 816 may retain Database 820, comprising a plurality of data items. For example, Database 820 may store the part catalogues of handled vehicles, the car type lists, the general part list, the division into part complexes, the association of general parts to car-model specific parts, and optionally additional data.

Database 820 may also comprise one or more tables or other data structures for cases, such as accidents, including the details of the involved vehicles, the impact characteristics for each vehicle, the sensor readings if available, the output of the engines, the reports, changes introduced to the reports by human appraisers, or the like.

Database 820 may also store trained specific prediction engine and agnostic prediction engine, and optionally historical versions thereof. However, trained specific prediction engine and/or agnostic prediction engine may be implemented as executables, stored on Storage Device 816 and not necessarily within Database 820.

Database 820 may be stored locally, remotely, on cloud storage, or distributed between different platforms and environments.

Storage Device 816 may retain User Interface 822, for displaying to a user the generated report, and optionally earlier stages. User Interface 822 may also display to the user various stages in the process for the user to enter data, confirm displayed data, or introduce amendments, such as the area and severeness of the impact, damaged parts, labor estimation, costs, or the like.

User Interface 822 may be displayed over visual I/O Device 808, played over a speaker, printed, or the like.

Storage Device 816 may retain Impact Determination Module 824 for receiving readings from one or more sensors such as IMU sensors, accelerometers, gyroscopes, radars, vehicle diagnostic sensors, or the like, installed in a vehicle, and calculating the area and severeness of an impact applied to the vehicle. Further data may be collected from non-physical force sensors such as car diagnostics systems, damage image recognition, radars or the like.

The input from the various sources may be fused or otherwise combined to obtain the area and severeness of the impact.

Storage Device 816 may retain Detail Obtaining Module 828, for obtaining various data items from Database 820 or other sources, such as car details, accident details, information from catalogues, or the like.

Storage Device 816 may retain Data and Control Flow Module 832 for operating Detail Obtaining Module 828 for obtaining the data relevant to a case, including all vehicle details, relevant data of the car model, or the like, determining whether to activate the specific prediction engine or the agnostic prediction engine, applying the selected engine to the input data, and operating report generation module 844 detailed below. Data and Control Flow Module 832 may also be configured to store cases and use them later on for training one or more engines.

Storage Device 816 may retain Engine Execution Module 836 for applying a selected engine, which may be specific prediction engine or agnostic prediction engine to the details of a current case.

Storage Device 816 may retain Engine Training Module 840 for training a selected engine, such as the specific prediction engine or agnostic prediction engine with one or more cases. For example, once a sufficient number of cases is available for a new car model, Storage Device 816 may operate Engine Execution Module 836 for applying a selected engine, which may be specific prediction engine or agnostic prediction engine to the details of a current case.

Storage Device 816 may retain Report Generation module 836 for generating a report for a case, including for example the parts to be replaced or repaired, the costs, or the like. The report may also comprise details about the accident, and additional details.

The report may be transmitted to one or more recipients, such as the car owner, the driver, the insurance company, or the like.

The present disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the invention in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
automatically deciding to use an agnostic prediction engine, wherein the agnostic prediction engine is agnostic to vehicle model, wherein the agnostic prediction engine is configured to provide an expected probability of each complex of parts of a model-less vehicle to be damaged by an impact of given impact characteristics;
obtaining impact characteristics describing impact caused to a specific vehicle, the specific vehicle is of a specific vehicle model;
applying the agnostic prediction engine to the impact characteristics and a type of the specific vehicle, to obtain a prediction of a list of complexes of parts of the model-less vehicle that have been damaged by the impact caused to the specific vehicle;
mapping the list of complexes of parts of the model-less vehicle to a list of damaged parts of the specific vehicle, wherein the list of damaged parts is larger than the list of complexes of parts of the model-less vehicle, wherein said mapping is performed utilizing a catalog of parts of the specific vehicle model; and
reporting the list of damaged parts of the specific vehicle.

2. The method of claim 1, wherein said automatically deciding comprises determining that a specific prediction engine has not been trained for the vehicle model.

3. The method of claim 1 further comprising using the impact characteristics and the list of complexes to train a specific engine for the specific vehicle model.

4. The method of claim 3 further comprising:
obtaining second impact characteristics describing a second impact caused to a second vehicle, of the specific vehicle model;
automatically deciding to use a specific prediction engine configured to provide an expected probability of each complex of parts of the second vehicle of the specific vehicle model to be damaged by an impact of the second impact characteristics;
applying the specific prediction engine to the second impact characteristics, to obtain the specific prediction of the list of complexes of parts of the second vehicle that have been damaged by the second impact caused to the second vehicle;
mapping the list of complexes of parts of the second vehicle to a list of damaged parts of the second vehicle, wherein the list of damaged parts is larger than the list of part complexes, wherein said mapping is performed utilizing a catalog of parts of the specific vehicle model; and
reporting the list of damaged parts of the specific vehicle.

5. The method of claim 1, wherein said agnostic model receives as input a type of the specific vehicle.

6. The method of claim 1, wherein the agnostic prediction engine or the specific prediction engine is a classifier.

7. The method of claim 1, wherein the specific prediction engine is trained upon with a plurality of specific car models for which specific data is available.

8. The method of claim 1, further comprising:
receiving from a user a correction to the at least one part or the degree of damage; and
learning from the correction for improving future identification of the at least one part complex or the degree of damage.

9. The method of claim 1, further comprising:
retrieving a price for replacing or repairing each part of the at least one part;
outputting the price for each part of the at least one part; and
outputting a total price calculated by summing the price for each part of the at least one part.

10. A system having a processor, the processor being adapted to perform the steps of:
automatically deciding to use an agnostic prediction engine, wherein the agnostic prediction engine is agnostic to vehicle model, wherein the agnostic prediction engine is configured to provide an expected probability of each complex of parts of a model-less vehicle to be damaged by an impact of given impact characteristics;
obtaining impact characteristics describing impact caused to a specific vehicle, the specific vehicle is of a specific vehicle model;
applying the agnostic prediction engine to the impact characteristics and a type of the specific vehicle, to obtain a prediction of a list of complexes of parts of the model-less vehicle that have been damaged by the impact caused to the specific vehicle;
mapping the list of complexes of parts of the model-less vehicle to a list of damaged parts of the specific vehicle, wherein the list of damaged parts is larger than the list of complexes of parts of the model-less vehicle, wherein said mapping is performed utilizing a catalog of parts of the specific vehicle model; and
reporting the list of damaged parts of the specific vehicle.

11. The system of claim 10, wherein said automatically deciding comprises determining that a specific prediction engine has not been trained for the vehicle model.

12. The system of claim 10 wherein the processor or a second processor is further configured to use the impact characteristics and the list of complexes to train a specific engine for the specific vehicle model.

13. The system of claim 12 wherein the processor or the second processor is further configured to:
obtain second impact characteristics describing a second impact caused to a second vehicle, of the specific vehicle model;
automatically decide to use a specific prediction engine configured to provide an expected probability of each complex of parts of the second vehicle of the specific vehicle model to be damaged by an impact of the second impact characteristics;
apply the specific prediction engine to the second impact characteristics, to obtain the specific prediction of the list of complexes of parts of the second vehicle that have been damaged by the second impact caused to the second vehicle;
map the list of complexes of parts of the second vehicle to a list of damaged parts of the second vehicle, wherein the list of damaged parts is larger than the list of part complexes, wherein said mapping is performed utilizing a catalog of parts of the specific vehicle model; and
report the list of damaged parts of the specific vehicle.

14. The system of claim 10, wherein said agnostic model receives as input a type of the specific vehicle.

15. The system of claim 10, wherein the agnostic prediction engine or the specific prediction engine is a classifier.

16. The system of claim 10, wherein the specific prediction engine is trained upon with a plurality of specific car models for which specific data is available.

17. The system of claim 10 wherein the processor is further configured to:
receive from a user a correction to the at least one part or the degree of damage; and
learn from the correction for improving future identification of the at least one part complex or the degree of damage.

18. The system of claim 10 wherein the processor is further configured to:
retrieve a price for replacing or repairing each part of the at least one part;
output the price for each part of the at least one part; and
output a total price calculated by summing the price for each part of the at least one part.

19. A computer program product comprising a non-transitory computer readable medium retaining program instructions, which instructions when read by a processor, cause the processor to perform:
automatically deciding to use an agnostic prediction engine, wherein the agnostic prediction engine is agnostic to vehicle model, wherein the agnostic prediction engine is configured to provide an expected probability of each complex of parts of a model-less vehicle to be damaged by an impact of given impact characteristics;
obtaining impact characteristics describing impact caused to a specific vehicle, the specific vehicle is of a specific vehicle model;
applying the agnostic prediction engine to the impact characteristics and a type of the specific vehicle, to obtain a prediction of a list of complexes of parts of the model-less vehicle that have been damaged by the impact caused to the specific vehicle;
mapping the list of complexes of parts of the model-less vehicle to a list of damaged parts of the specific vehicle, wherein the list of damaged parts is larger than the list of complexes of parts of the model-less vehicle, wherein said mapping is performed utilizing a catalog of parts of the specific vehicle model; and
reporting the list of damaged parts of the specific vehicle.
